(19) United States
(12) Patent Application Publication
(10) Pub. No.: US 2008/0145776 A1
(43) Pub. Date: Jun. 19, 2008

(54) Method of preparing toner and toner prepared using the method

(75) Inventors: Yo-da Shin, Metropolitan-city (KR); Tae-hoe Koo, Seoul (KR); Kyung-yol Yon, Seongnam-si (KR); Min-young Cheong, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/898,747

(22) Filed: Sep. 14, 2007

(30) Foreign Application Priority Data
Dec. 19, 2006 (KR) 10-2006-0130365

(51) Int. Cl. G03G 9/093; G03G 13/06; G03G 15/08

(52) U.S. Cl. 430/110.2; 399/258; 430/125.5; 430/137.12

(57) ABSTRACT

A method of preparing toner includes: preparing a primary latex by polymerizing a toner composition including a macromonomer having a hydrophilic group, a hydrophobic group and at least one reactive functional group, and at least one polymerizable monomer; preparing a primary agglomerated toner by mixing the primary latex with a pigment dispersion dispersed by the macromonomer and adding an inorganic salt to the mixture; and coating the primary agglomerated toner using a secondary latex including a core formed by polymerizing the macromonomer and at least one polymerizable monomer, a wax layer formed on the core by applying a dispersion in which at least one polymerizable monomer is dispersed in a wax, and a shell layer formed on the wax layer by adding at least one polymerizable monomer to the wax layer. A toner prepared by the method is also provided. According to the method, the manufacture process of toner can be simplified, the amount of wastewater can be minimized by reducing the amount of a surfactant, charge stability, durability, fusing ratio and glossiness of the final toner can be improved by coating the secondary latex having a relatively higher Tg than the primary latex and including a wax layer and a shell layer, and the shape and size of toner particles can be regulated.

### CROSS-REFERENCE TO RELATED PATENT APPLICATION

This application claims the benefit of Korean Patent Application No. 10-2006-0130365, filed on Dec. 19, 2006, in the Korean Intellectual Property Office, the disclosure of which is hereby incorporated by reference in its entirety.

### BACKGROUND OF THE INVENTION

1. Field of the Invention

The present invention relates to a method of preparing toner and to the toner prepared using the method. More particularly, the invention relates to a method of preparing toner by a simplified manufacture process, by minimizing the amount of wastewater using a reduced amount of a surfactant, thereby improving charge stability, durability, fusing ratio and glossiness of a final toner. The method includes the steps of coating a secondary latex having a relatively higher Tg than a primary latex and including a wax layer and a shell layer, and regulating shape and size of toner. The invention is further directed to a method of producing an image using the toner, and to an image forming apparatus employing the toner.

2. Description of the Related Art

In an electrophotographic process or an electrostatic recording process, developers used to shape an electrostatic image or an electrostatic latent image are classified into a two-component developer formed of toner and carrier particles, and a one-component developer formed of toner only. The one-component developer is classified into a magnetic one-component developer and a nonmagnetic one-component developer. Fluidizing agents such as colloidal silica are often independently added to the nonmagnetic one-component developer to increase the fluidity of the toner. Typically, coloring particles obtained by dispersing a pigment, such as carbon black, or other additives in a binding resin are used in the toner.

Methods of preparing toner include pulverization or polymerization. In the pulverization method, toner is obtained by melting and mixing synthetic resins with pigments and, if required, other additives, pulverizing the mixture and sorting the particles until particles of a desired size are obtained. In the polymerization method, a polymerizable monomer composition is manufactured by uniformly dissolving or dispersing various additives such as a pigment, a polymerization initiator and, if required, a cross-linking agent and an antistatic agent in a polymerizable monomer. Then, the polymerizable monomer composition is dispersed in an aqueous dispersive medium which includes a dispersion stabilizer using an agitator to shape minute liquid droplet particles. Subsequently, the temperature is increased and suspension polymerization is performed to obtain polymerized toner having coloring polymer particles of a desired size.

In an image forming device such as an electrophotographic device or an electrostatic recording device, an image is formed by exposing an image on a uniformly charged photoreceptor to form an electrostatic latent image, attaching toner to the electrostatic latent image to form a toned image, transferring the toned image onto a transfer member such as transfer paper or the like, and then fixing the unfixed toned image on the transfer member by means of various methods, including heating, pressurizing, solvent steaming and the like. In most fixing processes, the transfer medium with the toner image passes through fixing rollers and pressing rollers, and by heating and pressing, the toner image is fused to the transfer medium.

Images formed by an image forming apparatus such as an electrophotocopier should satisfy requirements of high precision and accuracy. Conventionally, toner used in an image forming apparatus is usually obtained using a pulverization method. In the pulverization method, color particles having a large range of sizes are formed. Hence, to obtain satisfactory developing properties, there is a need to sort the coloring particles obtained through pulverization according to size to reduce the particle size distribution. However, it is difficult to precisely control the particle size and the particle size distribution using a conventional mixing/pulverizing process in the manufacture of toner particles suitable for an electrophotographic process or an electrostatic recording process. Also, when preparing a fine particle toner, the toner preparation yield is low due to a sorting process. In addition, there is a limit to a change/adjustment of a toner design for obtaining desirable charging and fixing properties. Accordingly, polymerized toner, the size of particles of which is easy to control and which do not need to undergo a complex manufacturing process such as sorting, have been highlighted recently.

When toner is prepared through polymerization, polymerized toner having a desired particle size and particle size distribution can be obtained without pulverizing or sorting. However, although such polymerization is used, a surfactant is required to disperse a pigment. The use of the surfactant results in a washing process, and thus manufacturing costs increases and the amount of wastewater increases.

For example, U.S. Pat. No. 6,258,911 to Michael et al. discloses a bifunctional polymer having a narrow polydispersity and a method of emulsification-aggregation polymerization for preparing a polymer having free radicals that are covalently-bonded at both ends of the polymer. In such an emulsification-aggregation polymerization, toner particles are prepared by separately preparing a wax dispersion and a pigment dispersion using an ionic surfactant (typically an anionic surfactant), dispersing the prepared polymer latex particles with the wax dispersion and the pigment dispersion using a surfactant, and then agglomerating the resultant dispersion. Alternatively, a polymer latex (or seed) is polymerized in a first operation, and the seed is polymerized with a wax-monomer emulsified dispersion using a seed-treated emulsion polymerization in a second operation, and then toner particles are prepared by agglomerating the dispersed pigment using a surfactant. A method of preparing toner using the conventional emulsification-aggregation is complicated and the surfactant cannot be easily removed, resulting in various problems due to residual surfactant. Particularly, the conventional methods require an additional operation such as washing toner and thus contaminate environment and increase manufacturing costs.

### SUMMARY OF THE INVENTION

The present invention provides a method of preparing toner and the toner prepared using the method. More particularly, the invention provides a method of preparing toner by simplifying the manufacture process, minimizing the amount of wastewater by reducing the amount of a surfactant, improving charge stability, durability, fusing ratio and glossiness of a final toner, and regulating shape and size of toner.

The present invention also provides toner prepared using the method.

The present invention also provides toner having improved charge stability, durability, fusing ratio and glossiness. The method enables the shape and size of the toner to be easily controlled.

The present invention also provides an image forming method capable of fixing a high quality image at a low temperature using the toner having improved charge stability, durability, fusing ratio and glossiness, and controlled shape and size.

The present invention also provides an image forming apparatus capable of fixing high quality image at a low temperature using toner having improved charge stability, durability, fusing ratio and glossiness, the shape and size of which is easily controlled.

According to an aspect of the present invention, a method of preparing toner is provided, the method including:

preparing a primary latex by polymerizing a toner composition including a macromonomer having a hydrophilic group, a hydrophobic group and at least one reactive functional group, and at least one polymerizable monomer;

preparing a primary agglomerated toner by mixing the primary latex with a pigment dispersion with the macromonomer and adding an inorganic salt to the mixture; and

coating the primary agglomerated toner with a secondary latex including a core formed by polymerizing the macromonomer and the at least one polymerizable monomer, a wax layer on the core formed by applying a dispersion in which at least one polymerizable monomer is dispersed in a wax, and a shell layer on the wax layer formed by adding at least one polymerizable monomer.

According to another aspect of the present invention, a toner is prepared using a method including: preparing a primary latex by polymerizing a toner composition including a macromonomer having a hydrophilic group, a hydrophobic group and at least one reactive functional group, and at least one polymerizable monomer; preparing a primary agglomerated toner by mixing the primary latex with a pigment dispersion dispersed by the macromonomer and adding an inorganic salt to the mixture; and coating the primary agglomerated toner using a secondary latex including a core formed by polymerizing the macromonomer and at least one polymerizable monomer, a wax layer formed by applying a dispersion to the core where the dispersion has at least one polymerizable monomer dispersed in a wax, and a shell layer formed by adding at least one polymerizable monomer to the wax layer.

According to another aspect of the present invention, an image forming method is provided using the toner, the method including attaching the toner to the surface of a photoreceptor on which an electrostatic latent image is formed to form a visualized image and transferring the visualized image to a transfer medium, wherein the toner is prepared using a method including: preparing a primary latex by polymerizing a toner composition including a macromonomer having a hydrophilic group, a hydrophobic group and at least one reactive functional group, and at least one polymerizable monomer; preparing a primary agglomerated toner by mixing the primary latex with a pigment dispersion dispersed by the macromonomer and adding an inorganic salt to the mixture; and coating the primary agglomerated toner using a secondary latex that includes a core formed by polymerizing the macromonomer and at least one polymerizable monomer, a wax layer on the core formed by applying a dispersion in which at least one polymerizable monomer is dispersed in a wax, and a shell layer on the wax layer formed by adding at least one polymerizable monomer to the wax layer.

According to another aspect of the present invention, an image forming apparatus is provided including: an organic photoreceptor; an image forming unit that forms an electrostatic latent image on a surface of the organic photoreceptor; a unit for receiving toner prepared using a method including: preparing a primary latex by polymerizing a toner composition including a macromonomer having a hydrophilic group, a hydrophobic group and at least one reactive functional group, and at least one polymerizable monomer; preparing a primary agglomerated toner by mixing the primary latex with a pigment dispersion dispersed by the macromonomer and adding an inorganic salt to the mixture; and coating the primary agglomerated toner using a secondary latex that includes a core formed by polymerizing the macromonomer and at least one polymerizable monomer, a wax layer on the core formed by applying a dispersion in which at least one polymerizable monomer is dispersed in a wax to the core, and a shell layer on the wax layer formed by adding at least one polymerizable monomer to the wax layer; a toner supplying unit that supplies the toner onto the surface of the organic photoreceptor in order to form a toner image by developing the electrostatic latent image; and a toner transferring unit that transfers the toner image to a transfer medium from the surface of the organic photoreceptor.

These and other aspects of the invention will become apparent from the following detailed description of the invention, which in conjunction with the drawings, disclose various embodiments of the invention.

### BRIEF DESCRIPTION OF THE DRAWINGS

These and other features and advantages of the present invention will become more apparent by describing in detail exemplary embodiments thereof with reference to the attached drawings in which:

FIG. 1 is an image forming apparatus employing toner prepared according to an embodiment of the present invention;

FIG. 2 is a scanning electron microscope (SEM) image of toner prepared according to Example 1;

FIG. 3 is a SEM image of toner prepared according to Example 2;

FIG. 4 is a SEM image of toner prepared according to Example 3;

FIG. 5 is a SEM image of toner prepared according to Example 4;

FIG. 6 is a SEM image of toner prepared according to Example 5;

FIG. 7 is a SEM image of toner prepared according to Comparative Example 1;

FIG. 8 is a SEM image of toner prepared according to Comparative Example 2;

FIG. 9 is a SEM image of toner prepared according to Comparative Example 3;

FIG. 10 is a SEM image of toner prepared according to Comparative Example 4; and

FIG. 11 is a SEM image of toner prepared according to Comparative Example 5.

### DETAILED DESCRIPTION OF THE INVENTION

Hereinafter, the present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

The present invention provides a method of preparing toner by simplifying the manufacturing processes, and minimizing the amount of wastewater by using reduced amount of a surfactant. The resulting toner has improved charge stability, durability, fusing ratio and glossiness. The method also enables regulating shape and size of the toner. Particularly, the amount of the surfactant can be dramatically reduced while the dispersing ability to a pigment is maintained by dispersing the pigment using a macromonomer which has dispersing ability with a hydrophilic group and a hydrophobic group. Accordingly, various problems caused by excessive use of the surfactant can be solved.

Further, charge stability, durability, fusing ratio, and glossiness of the final toner can be improved by coating a secondary latex having a relatively higher Tg than a primary latex, and including a wax layer and a shell layer, and toner for a high-speed printer with high image quality in which the shape and size of the toner can be easily adjusted can be prepared. That is, Tg increases as the amount of polymerizable monomer increases since Tg of the toner is determined by a composition ratio of latexes, and thus the secondary latex can have a higher Tg than the primary latex by increasing the amount of the polymerizable monomer in the secondary latex.

The present invention provides a method of preparing toner, the method comprising:

preparing a primary latex by polymerizing a toner composition comprising a macromonomer having a hydrophilic group, a hydrophobic group and at least one reactive functional group, and at least one polymerizable monomer;

preparing a primary agglomerated toner by mixing the primary latex with a pigment dispersion dispersed by the macromonomer to form a mixture and adding an inorganic salt to the mixture; and

coating the primary agglomerated toner using a secondary latex comprising a core formed by polymerizing the macromonomer and at least one polymerizable monomer, a wax layer on the core formed by applying a dispersion in which at least one polymerizable monomer is dispersed in a wax, and a shell layer formed on the wax layer by adding at least one polymerizable monomer to the wax layer.

The macromonomer used herein is an amphiphilic material which has a hydrophilic group and a hydrophobic group in a polymer or oligomer form and having at least one reactive functional group at its end.

The hydrophilic group of the macromonomer which is chemically combined on the surface of toner particles improves long term stability of the toner particles by steric stabilization, and can adjust the size of latex particles according to the amount or molecular weight of the added macromonomer. The hydrophobic group of the macromonomer exists on the surface of the toner particles and can facilitate emulsion polymerization reaction. The macromonomer may form a copolymer with the polymerizable monomer included in the toner composition by grafting, branching, cross-linking, or the like.

A weight average molecular weight of the macromonomer may be in the range of about 100 to about 100,000, and preferably about 1,000 to about 10,000. When the weight average molecular weight of the macromonomer is less than 100, the physical properties of the toner are not improved or the toner cannot function efficiently as a stabilizer. On the other hand, when the weight average molecular weight of the macromonomer is greater than 100,000, the reaction conversion rate may be lowered.

The macromonomer may be a material selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate, but is not limited thereto.

The macromonomer can function not only as a comonomer but also as a stabilizer. Initial reaction of radicals and monomers creates oligomer radicals and shows an in-situ stabilization effect. An initiator dissolved by heat creates radicals and reacts with a monomer in an aqueous solution to form an oligomer radical, and the hydrophobicity of the solution increases. Such hydrophobicity of oligomer radicals facilitates diffusion into micelle and reaction with polymerizable monomers, and together with this, a copolymerization reaction with macromonomers can be processed.

Due to the hydrophilicity of the macromonomer, copolymerization can easily occur in the vicinity of the surface of the toner particles. The hydrophilic portions of the macromonomer located on the surface of the toner particles increase the stability of the toner particles by steric stabilization, and the size of the toner particles can be adjusted according to the amount or molecular weight of the macromonomers. Also, functional groups reacting on the surface of the toner particles can improve the frictional electricity of the toner.

The polymerizable monomer may be at least one monomer selected from the group consisting of a vinyl monomer, a polar monomer having a carboxyl group, a monomer having an unsaturated polyester group, and a monomer having a fatty acid group.

The polymerizable monomer may be at least one selected from the group consisting of styrene based monomers such as styrene, vinyl toluene, α-methyl styrene; acrylic acid, methacrylic acid; derivatives of (meth)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide; ethylenically unsaturated monoolefins such as ethylene, propylene, butylenes; halogenated vinyls such as vinyl chloride, vinylidene chloride, vinyl fluoride; vinyl esters such as vinyl acetate, vinyl propionate; vinyl ethers such as vinyl methyl ether, vinyl ethyl ether; vinyl ketones such as vinyl methyl ketone, methyl isoprophenyl ketone; and nitrogen-containing vinyl compounds such as 2-vinylpyridine, 4-vinylpyridine, N-vinyl pyrrolidone, but is not limited thereto.

The toner composition according to the present invention includes 0.1 to 10 parts by weight, preferably 2 to 6 parts by weight, and more preferably 2 to 4 parts by weight of the macromonomer based on 100 parts by weight of the polymerizable monomer.

When the amount of the macromonomer is less than 0.1 parts by weight, dispersion stability of the toner particles may decrease and yield may decrease. On the other hand, when the amount of the macromonomer is greater than 10 parts by weight, physical properties of the toner may deteriorate.

A medium used herein may be an aqueous solution, an organic solvent, or a mixture thereof.

The toner may include a pigment. Carbon black or aniline black may be used as the pigment for producing a black toner. A nonmagnetic toner according to the present invention is efficient for preparing color toner. For color toner, carbon black or aniline black is used as a black colorant, and at least one of yellow, magenta, and cyan pigments are further included as colorants for producing colored toners.

A condensation nitrogen compound, an isoindolinone compound, anthraquinone compound, an azo metal complex, or an alyl imide compound can be used for the yellow pigment. Particularly, C.I. pigment yellow 12, 13, 14, 17, 62, 74, 83, 93, 94, 95, 109, 110, 111, 128, 129, 147, 168, 180 or the like can be used.

A condensation nitrogen compound, an anthraquinone, quinacridone compound, base dye lake compound, naphthol compound, benzo imidazole compound, thioindigo compound, or perylene compound can be used for the magenta pigment. Particularly, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, or the like can be used.

A copper phthlaocyanine compound and derivatives thereof, anthraquinone compound, or base dye lake compound can be used for the cyan pigment. Particularly, C.I. pigment blue 1, 7, 15, 15:1, 15:2, 15:3, 15:4, 60, 62, 66, or the like can be used.

Such pigments can be used alone or in a combination of at least two pigments, and are selected in consideration of color, chromacity, luminance, resistance to weather, dispersion property in toner, etc.

The amount of the pigment as described above is preferably 0.1 to 20 parts by weight based on 100 parts by weight of the polymerizable monomer. The amount of the pigment should be sufficient to color the toner to the desired level. However, when the amount of the pigment is less than 0.1 parts by weight based on 100 parts by weight of the polymerizable monomer, the coloring effect is generally not sufficient. On the other hand, when the amount of the pigment is greater than 20 parts by weight, the manufacture costs of the toner increase, and sufficient frictional charge cannot be obtained.

In addition, a primary agglomerated toner is prepared by adding an inorganic salt to a mixed solution of latex particles for a core and a pigment dispersion to generate aggregation. That is, the size of the primary agglomerated toner increases due to increased ionic strength by the addition of the inorganic salt and collisions or interactions between the particles.

Particularly, when a concentration of the inorganic salt is heavier than a critical coagulation concentration (CCC), an electrostatic repulsive force between polymer latex particles is offset, and thus aggregation rapidly occurs due to Brownian motion of the polymer latex particles. When a concentration of the inorganic salt is lower than the CCC, aggregation speed is slow, and thus aggregation of polymer latex particles can be controlled. Here, examples of the inorganic salt include at least one salt selected from the group consisting of NaCl, MgCl₂.8H₂0, [Al₂(OH)ₙCl₆₋ₙ]ₘ where 1≦n≦5, 1≦m≦10, and (Al₂(SO₄)₃.18H₂O), but are not limited thereto.

The preparation of a primary latex according to the present invention may be performed further using an initiator, a chain transfer agent, a charge control agent, and a release agent.

In the preparation process, radicals may be created by the initiator in the toner composition, and the radicals may react with the polymerizable monomer. The radicals may form a copolymer by reacting with the polymerizable monomer and reactive functional groups of the macromonomer.

Examples of the initiator for radical polymerization include persulfate salts such as potassium persulfate, ammonium persulfate, etc.; azo compounds such as 4,4-azobis(4-cyano valeric acid), dimethyl-2,2′-azobis(2-methylpropionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) etc.; peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and others. Also, an oxidization-reduction initiator in which the polymerization initiator and a reduction agent are combined may be used.

A chain transfer agent is a material that converts a type of a chain carrier in a chain reaction. A new chain has much less activity than that of a previous chain. The polymerization degree of the monomer can be reduced and new chains can be initiated using the chain transfer agent. In addition, a molecular weight distribution of the polymer latex can be adjusted using the chain transfer agent.

Examples of the chain transfer agent include sulfur containing compounds such as dodecanthiol, thioglycolic acid, thioacetic acid, and mercaptoethanol; phosphorous acid compounds such as phosphorous acid and sodium phosphite; hypophosphorous acid compounds such as hypophosphorous acid and sodium hypophosphite; and alcohols such as methyl alcohol, ethyl alcohol, isopropyl alcohol, and n-butyl alcohol, but are not limited thereto.

The release agent can be used to protect a photoreceptor and prevent deterioration of developing, thereby obtaining a high quality image. A release agent may be a high purity solid fatty acid ester material. Examples of the release agent include low molecular weight polyolefins such as low molecular weight polyethylene, low molecular weight polypropylene, low molecular weight polybutylenes, and the like; paraffin wax; multi-functional ester compound, and the like. The release agent used in the present invention may be a multifunctional ester compound composed of alcohol having three functional groups or more and carboxylic acid.

The polyhydric alcohol with at least three functional groups may be an aliphatic alcohol, such as glycerin, pentaerythritol, pentaglycerol; an alicyclic alcohol, such as chloroglycitol, quersitol, inositol; an aromatic alcohol, such as tris(hydroxymethyl)benzene; a sugar, such as D-erythrose, L-arabinose, D-mannose, D-galactose, D-fructose, L-lamunose, sucrose, maltose, lactose; or a sugar-alcohol, such as erythrite.

The carboxylic acid may be an aliphatic carboxylic acid, such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, tetrolic acid; an alicyclic carboxylic acid, such as cyclohexanecarboxylic acid, hexahydroisophthalic acid, hexahydroterephthalic acid, 3,4,5,6-tetrahydrophthalic acid; or an aromatic carboxylic acid, such as benzoic acid, cumic acid, phthalic acid, isophthalic acid, terephthalic acid, trimeth acid, trimellitic acid, hemimellitic acid.

The charge control agent may be preferably selected from the group consisting of a salicylic acid compound containing metals such as zinc and aluminum, boron complexes of bis diphenyl glycolic acid, and silicate. More preferably, dialkyl salicylic acid zinc, boro bis (1,1-diphenyl-1-oxo-acetyl potassium salt), etc. can be used.

The method of preparing toner according to the present invention includes coating the primary agglomerated toner using a secondary latex, and the secondary latex includes a core formed by polymerizing the macromonomer and at least one polymerizable monomer, a wax layer formed by applying a dispersion in which at least one polymerizable monomer is dispersed in a wax to the core, and a shell layer formed by adding at least one polymerizable monomer to the wax layer.

As described above, the structure formed by coating the primary agglomerated toner using the second latex improves fixing properties of the final toner at a low temperature and rheological properties.

That is, the rheological properties is determined by complex modulus, i.e., storage modulus (G′) and loss modulus (G′) by dynamic tests, and controlled by complex viscosity. In addition, relaxation modulus of elasticity and relaxation time can be measured. Such stress-relaxation behavior is affected by molecular weight and structure of the polymer latex in the toner and the amount of wax contained in the toner. When the complex viscosity is too low (less than 1.0×10² Pas), offset or peeling failure may occur in a fusing device. On the other hand, when the complex viscosity is too high (higher than 1.0×10⁴ Pas), adhesion may not be sufficient when fused and glossiness may decrease, and thus the toner is not efficiently applied to paper.

Meanwhile, when the weight average molecular weight (Mw) of the polymer latex is controlled less than 30,000, Tg is controlled at about 50° C., and rheological properties are decreased, the fusing ratio can be increased, but problems such as offset may occur. To overcome such problems, a method of cross-linking the latex has been used by controlling reactivity of the macromonomer participating the polymerization. However, problems such as durability have not been completely overcome.

Accordingly, in the present invention toner is encapsulated by coating toner particles using the secondary latex to improve durability and to solve storage problems during shipping and handling.

When the primary agglomerated toner is coated using the second latex, the pigment in the primary agglomerated toner migrates to the surface of the toner and thus reduction in charge property can be complemented

Further, toner according to the present invention has more advantageous effects since the secondary latex includes a wax layer and a shell layer compared to conventional toners.

That is, since the secondary latex includes the wax layer, the wax can be uniformly distributed and thus the wax content can be increased. As a result, optical density and glossiness of the final toner can be improved. Further, the shell layer formed on the wax layer can prevent caking of the toner particles, in which toner particles agglomerate to each other at a high temperature when wax having low melting point (Tm) comes out of the surface of the toner particles. The shell layer also can increase fusing ratio of the toner.

The macromonomer and at least one polymerizable monomer used to form the core, the wax layer, and the shell layer of the secondary latex may be the same macromonomer and at least one polymerizable monomer used in the primary latex.

Further, the polymerizable monomer may be a polymerizable monomer having at least 3 cross-linkable functional groups to function as a cross-linking agent. Examples of the polymerizable monomer may include triallyl isocyanurate, (di)ethylene glycol di(meth)acrylate, trimethylolpropane, trimethylolethylene, triacrylate, divinyl pyridine, quinone dioxime, benzoquinone dioxime, p-nitrosophenol, and N,N′-m-phenylene-bismaleimide, and preferably multifunctional (meth)acrylate such as pentaerythritol triacrylate or trimethylol propanetri(meth)acrylate, but are not limited thereto.

In addition, the secondary latex may include a charge control agent to improve charge stability of the final toner. The amount of the charge control agent may be in the range of 1 to 5 parts by weight based on 100 parts by weight of the polymerizable monomer forming the core. When the amount of the charge control agent is less than 1 part by weight, the effect of the charge control is negligible. When the amount of the charge control agent is greater than 5 parts by weight, polymerization degree may decrease. The same charge control agent used for the primary latex can be used herein.

The charge control agent may be preferably selected from the group consisting of a salicylic acid compound containing metals such as zinc and aluminum, boron complexes of bis diphenyl glycolic acid, and silicate. More preferably, dialkyl salicylic acid zinc, boro bis (1,1-diphenyl-1-oxo-acetyl potassium salt), and others can be used.

Processes of preparing a primary latex and a primary agglomerated toner and coating the primary agglomerated toner using a secondary latex according to the present invention will be described in detail.

First, a primary latex is prepared by polymerizing a toner composition including the macromonomer described above and at least one polymerizable monomer. More particularly, while the inside of a reactor was purged with nitrogen gas or the like, a mixture solution of a medium such as distilled deionized water (or a mixture of water and an organic solvent) and the macromonomer was added to the reactor and heated while stirring. An electrolyte or an inorganic salt such as NaOH or NaCl may be added thereto to adjust the ionic strength of the reacting medium. When the temperature inside the reactor reaches a certain level, an initiator preferably a water-soluble free radical initiator, may be introduced. Then, at least one polymerizable monomer may be added to the reactor using a semi-continual method with a chain transfer agent. Here, polymerizable monomers may be slowly added to the reactor using a starved feeding process to adjust a reaction speed and dispersibility of the solution.

The polymerization time which may be 2 to 12 hours is dependent on the reaction temperature and experimental conditions, and is determined by measuring reaction speed, conversion rate, and the like. The primary latex may be prepared by adding additional monomers to adjust the durability or other properties of the toner.

The primary latex of the present invention may include a wax layer formed from a dispersion of at least one polymerizable monomer and a wax. The wax dispersion can be prepared from the same or different monomers as in the initial polymerization step for preparing the primary latex. The wax dispersion is prepared by dissolving a wax in a solution of one or more polymerizable monomers and a chain transfer agent and dispersing the resulting solution in distilled water containing a macromonomer. The macromonomer is typically included in the same proportion as in the production of the primary latex. The macromonomer in the primary latex and the wax dispersion can be the same or different. That is, the wax layer is formed by adding the dispersion in which at least one polymerizable monomer mixed using a solvent is dispersed in a wax to a reactor containing the primary latex and further adding an initiator and the like. When the wax layer is formed, a shell layer may further be formed by adding at least one polymerizable monomer to the reactor. Here, an inhibitor may further be added to the reactor to prevent new latex particles from being formed. In addition, the reaction may be preformed using the starved-feeding processes to facilitate coating of the polymerizable monomer mixture on core particles.

The wax may be appropriately selected according to the purpose of the final toner. Examples of the wax that can be used include polyethylene-based wax, polypropylene-based wax, silicone wax, paraffin-based wax, ester-based wax, carbauna wax and, metallocene wax, but are not limited thereto. The melting point of the wax may be about 50 to about 150° C. Wax constituents are physically attached to the toner particles, but are preferably not covalently bonded with toner particles. Thus, a toner is produced that can be fixed at a low fixing temperature on a final image receptor and shows excellent final image durability and resistance to abrasion.

When the primary latex is prepared, a pigment is dispersed using the macromonomer since the macromonomer can maintain dispersibility with both of the hydrophilic group and the hydrophobic group on the macromonomer. A milling or a homogenizer may be used without limitation as dispersing equipment and the primary agglomerated toner may be prepared through agglomeration by adding an inorganic salt to the prepared pigment dispersion. The pigment dispersion in the macromonomer is added to the primary latex dispersed in water and the resulting mixture is reacted. The secondary latex is added and reacted. After cooling, the mixture is filtered and separated to obtain the agglomerated toner. The resulting particles are surface treated to obtain the toner particles.

The secondary latex may be prepared in a similar manner to a method of preparing the primary polymer latex using a composition including at least one polymerizable monomer. First, a core of the secondary latex is formed as follows. That is, while the inside of a reactor was purged with nitrogen gas or the like, a mixture solution of a medium such as distilled deionized water (or a mixture of water and an organic solvent) and the macromonomer is added to the reactor and heated while stirring. An electrolyte or an inorganic salt such as NaOH or NaCl may be added thereto to adjust the ionic strength of the reacting medium. When the temperature inside the reactor reaches a certain level, an initiator, which is preferably a water-soluble free radical initiator, may be introduced. Then, at least one polymerizable monomer may be added to the reactor using a semi-continual method, preferably with a chain transfer agent. Here, polymerizable monomers may be slowly added to the reactor using a starved feeding process to adjust a reaction speed and dispersibility of the solution.

When the core is formed as described above, a dispersion in which polymerizable monomers are dispersed in a wax and an initiator are introduced into the reactor. The wax dispersion may further include a medium such as deionized water and a chain transfer agent. As a result, the wax layer is formed on the core.

Subsequently, a shell layer is finally formed on the wax layer by adding at least one polymerizable monomer and the initiator. Here, the reaction may be sufficiently and slowly preformed using the starved-feeding processes to adjust reaction speed and dispersibility.

The reaction time to prepare the secondary latex, which may be 2 to 8 hours, is dependant on the reaction temperature and experimental conditions, and is determined by measuring reaction speed, conversion rate, and the like.

Then, the prepared secondary latex was coated onto the primary agglomerated toner to obtain toner particles having desired size and shape, and then the resultant was filtered to separate the toner particles and dried. The secondary latex is coated onto the primary latex forming a mixture of the primary latex with the pigment dispersion, adding the secondary latex, and reacting the mixture. The dried toner particles are subjected to a surface treatment using silica or the like and the charged electric charge amount thereof was adjusted to prepare a final dry toner.

Since the macromonomer used as a comonomer during the polymerization of the latex according to the present invention maintain stability of the latex in an aqueous solution, a surfactant does not need to be used in the preparation of the polymer latex particles and the agglomeration.

That is, at least one operation of the preparation of the primary latex, the preparation of the primary agglomerated toner, and the coating of the primary agglomerated toner using the secondary latex may be carried out without a surfactant.

Accordingly, washing process may be minimized in the separation and filtration of the prepared toner particles. Manufacturing costs for the toner may be reduced by minimizing the washing process, and the processes can be environmentally friendly by decreasing the amount of wastewater. Further, problems such as sensitivity in high humidity, low frictional charge, reduced dielectric property, and weak toner flow may be avoided or reduced since the surfactant is not used. Also, storage stability can be improved.

According to an embodiment of the present invention, a toner is prepared using a method comprising: preparing a primary latex by polymerizing a toner composition comprising a macromonomer having a hydrophilic group, a hydrophobic group and at least one reactive functional group, and at least one polymerizable monomer. A primary agglomerated toner is prepared by mixing the primary latex with a pigment dispersion dispersed by the macromonomer and adding an inorganic salt to the mixture. The primary agglomerated toner is then coated using a secondary latex comprising a core formed by polymerizing the macromonomer and at least one polymerizable monomer, a wax layer formed on the core by applying a dispersion in which at least one polymerizable monomer is dispersed in a wax, and a shell layer formed on the wax layer by adding at least one polymerizable monomer to the wax layer on the core.

At least one operation of the preparation of a primary latex, the preparation of a primary agglomerated toner, and the method of coating the primary agglomerated toner using a secondary latex is performed without the use of a surfactant. Detailed descriptions thereof are disclosed above. A volume average diameter of the prepared toner particles may be in the range of about 3 to about 20 μm, and preferably about 5 to about 8 μm.

The weight average molecular weight of the macromonomer may be in the range of about 100 to about 100,000, and preferably about 1,000 to about 10,000. Examples of the macromonomer may include polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate, but are not limited thereto.

According to an embodiment of the present invention, an image forming method using the toner includes attaching the toner to the surface of a photoreceptor on which an electrostatic latent image is formed to form a visualized image and transferring the visualized image to a transfer medium. The toner is prepared by preparing a primary latex by polymerizing a toner composition comprising a macromonomer having a hydrophilic group, a hydrophobic group and at least one reactive functional group, and at least one polymerizable monomer. A primary agglomerated toner is prepared by mixing the primary latex with a pigment dispersion dispersed by the macromonomer and adding an inorganic salt to the mixture. The primary agglomerated toner is coated using a secondary latex comprising a core formed by polymerizing the macromonomer and at least one polymerizable monomer, a wax layer formed on the core by applying a dispersion in which at least one polymerizable monomer is dispersed in a wax, and a shell layer formed by adding at least one polymerizable monomer to the wax layer on the core.

A representative electrophotographic image forming process includes the steps of charging, exposure to light, developing, transferring, fixing, cleaning, and antistatic process operations, and a series of processes of forming images on a receptor.

In the charging process, a surface of a photoreceptor is charged with negative or positive charges, whichever is desired, by a corona or a charge roller. In the light exposing process, an optical system, conventionally a laser scanner or an array of diodes, selectively discharges the charged surface of the photoreceptor in an imagewise manner corresponding to a final visual image formed on a final image receptor to form a latent image. Electromagnetic radiation that can be referred to as “light” includes infrared radiation, visible light, and ultraviolet radiation.

In the developing process, appropriate polar toner particles generally contact the latent image of the photoreceptor, and conventionally, an electrically-biased developer having identical potential polarity to the toner polarity is used. The toner particles move to the photoreceptor and are selectively attached to the latent image by electrostatic electricity, and form a toner image on the photoreceptor.

In the transferring process, the toner image is transferred to the final image receptor from the photoreceptor, and sometimes, an intermediate transferring element is used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix the toner on the final image receptor under high pressure with or without the application of heat.

In the cleaning process, remaining toner on the photoreceptor is removed.

Finally, in the antistatic process, charges of a medium/body of the photoreceptor are exposed to light of a predetermined wavelength band and are reduced to a substantially uniform, low value, and thus the residue of the original latent image is removed and the photoreceptor is prepared for a next image forming cycle.

According to an embodiment of the present invention, an image forming apparatus includes: an organic photoreceptor; a means charging the surface of the organic photoreceptor; an image forming unit that forms an electrostatic latent image on a surface of the organic photoreceptor; a unit for receiving the toner; a toner supplying unit that supplies the toner onto the surface of the organic photoreceptor in order to form a toner image by developing the electrostatic latent image; and a toner transferring unit that transfers the toner image to a transfer medium from the surface of the organic photoreceptor. The toner is prepared by preparing a primary latex by polymerizing a toner composition comprising a macromonomer having a hydrophilic group, a hydrophobic group and at least one reactive functional group, and at least one polymerizable monomer. A primary agglomerated toner is prepared by mixing the primary latex with a pigment dispersion dispersed by the macromonomer and adding an inorganic salt to the mixture. The primary agglomerated toner is coated using a secondary latex comprising a core formed by polymerizing the macromonomer and at least one polymerizable monomer, a wax layer formed on the core by applying a dispersion in which at least one polymerizable monomer is dispersed in a wax, and a shell layer on the wax layer formed by adding at least one polymerizable monomer to the wax layer on the core.

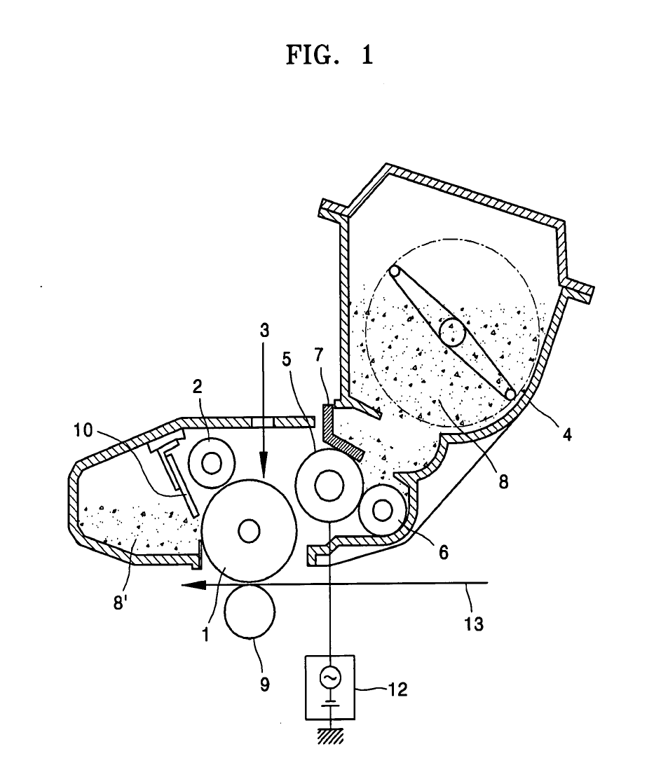

FIG. 1 is a schematic diagram of a non-contact developing type image forming apparatus using a toner prepared using the method according to an embodiment of the present invention. The operating principles of the image forming apparatus are explained below.

A developer 8, which is a nonmagnetic one-component developer of a developing unit 4, is supplied to a developing roller 5 through a feeding roller 6 formed of an elastic material such as a polyurethane foam or sponge. The developer 8 supplied to the developing roller 5 reaches a contact point between the developing roller 5 and a developer regulation blade 7 as the developing roller 5 rotates. The developer regulation blade 7 is formed of an elastic material such as metal, rubber, or the like. When the developer 8 passes the contact point between the developing roller 5 and the developer regulation blade 7, the developer 8 is smoothed to form a thin layer that is sufficiently charged. The developing roller 5 transfers the thin layer of the developer 8 to a developing domain where the thin layer of the developer 8 is developed on the electrostatic latent image of a photoreceptor 1, which is a latent image carrier. The electrostatic latent image is formed by scanning light 3 to the photoreceptor 1.

The developing roller 5 and the photoreceptor 1 face each other with a constant distance therebetween. The developing roller 5 rotates counterclockwise and the photoreceptor 1 rotates clockwise.

The developer 8 transferred to the developing domain of the photoreceptor 1 forms an electrostatic latent image on the photoreceptor 1 according to the intensity of an electric charge generated due to a difference between an AC voltage superposed with a DC voltage applied to the developing roller 5 by a charging unit 12 and a latent image potential of the photoreceptor 1 that is charged by a charging unit 2. Accordingly, a toner image is formed.

The developer 8 developed on the photoreceptor 1 is transferred to a transferring device 9 as the photoreceptor 1 rotates. The developer 8 developed on the photoreceptor 1 is transferred to a sheet of paper 13, and as the paper 13 passes through the developer 8 developed on the photoreceptor 1 as corona discharge or as a roller by a transfer unit 9 to which a high voltage having inverse polarity with respect to the developer 8 is applied, thus forming an image.

The image transferred to the printing paper 13 passes through a fusing device (not shown) that provides high temperature and high pressure, and the image is fused to the printing paper 13 as the developer 8 is fused to the printing paper 13. Meanwhile, the developer 8′ remaining on the developing roller 5 and which is not developed is transferred back to the feeding roller 6 contacting the developing roller 5. A remaining developer 8′ that is undeveloped on the photoreceptor 1 is collected by a cleaning blade 10.

The above processes are repeated.

The present invention will be described in more detail with reference to the examples below, but is not limited thereto. The following examples are for illustrative purposes only and are not intended to limit the scope of the invention.

### EXAMPLE 1

### Preparation of Primary Latex

While the inside of a reactor was purged with nitrogen gas, a mixture solution of 470 g of distilled deionized water and 5 g of poly(ethylene glycol)ethyl ether methacrylate (PEG-EEM, Aldrich) as a macromonomer was added to the reactor and heated while stirring at 250 rpm. When the temperature in the reactor reached 82° C., 2.0 g of potassium persulfate (KPS) as an initiator (water soluble free radical initiator) dissolved in 20 g of deionized water was introduced into the reactor. Then, 100 g of a polymerizable monomer mixture of styrene, n-butyl acrylate, and methacrylic acid in a weight ratio of 75:23:2 and 3.0 g of 1-dodecanthiol as a chain transfer agent were added to the reactor using a starved-feeding method. During the reaction, a wax dispersion was prepared from 15 g of ester wax slowly dissolved in a mixed solution comprising 28.1 g of a polymerizable monomer of styrene, n-butyl acrylate, and methacrylic acid in a weight ratio of 75:23:2 and 3.5 g of 1-dodecanethiol by heating, and dispersed in a mixed solution comprising 190 g of distilled water and 1.4 g of PEG-EEM as a macromonomer with the same ratio of the initial reaction. The prepared wax dispersion was added to the reactor and 1 g of KPS dissolved in 40 g of deionized water was also added to the reactor. The reaction was performed for 4 to 6 hours, and the resultant was cooled naturally while stirring. A volume average diameter of particles of latex for a core was 550 nm, and a conversion rate was about 98.8%.

Preparation of Secondary Latex

While the inside of a 1 l reactor was purged with nitrogen gas, a mixture solution of 470 g of distilled deionized water and 5 g of poly(ethylene glycol)ethyl ether methacrylate (PEG-EEM, Aldrich) as a macromonomer was added to the reactor and heated while stirring at 300 rpm. When the temperature in the reactor reached 82° C., 2.0 g of potassium persulfate (KPS) as an initiator dissolved in 50 g of deionized water was introduced into the reactor. Then, 100 g of a polymerizable monomer mixture of styrene, n-butyl acrylate, and methacrylic acid in a weight ratio of 78:20:2 and 3.0 g of 1-dodecanethiol as a chain transfer agent were added to the reactor using a starved-feeding method. During the reaction, 15 g of ester wax was slowly dissolved in a mixed solution comprising 28.1 g of a polymerizable monomer of styrene, n-butyl acrylate, and methacrylic acid in a weight ratio of 75:23:2 and 3.5 g of 1-dodecanethiol by heating, and dispersed in a mixed solution comprising 190 g of distilled water and 1.4 g of PEG-EEM as a macromonomer with the same ratio of the initial reaction to prepare a wax dispersion. The prepared wax dispersion was added to the reactor and 1 g of KPS dissolved in 40 g of deionized water was also added to the reactor. During the reaction, 1 g of KPS dissolved in 50 g of deionized water was slowly added to the reactor, and a mixed solution comprising 72 g of a polymerizable monomer of styrene, n-butyl acrylate, and methacrylic acid in a weight ratio of 78:23:2 and 3.5 g of 1-dodecanethiol was added thereto for 2 hours. The reaction was performed for 4 to 6 hours, and the resultant was cooled naturally while stirring. A volume average diameter of particles of the secondary latex was 380 nm, and a conversion rate was about 99.2%.

Preparation of Primary Agglomerated Toner and Toner

316 g of deionized water and 307 g of the primary latex prepared according to the process described above were added to a 1 L reactor and stirred at 350 rpm. While stirring, 30 g of black pigment dispersion which is dispersed in HS-10 (DAI-ICHI-KOGYO) as a macromonomer was added thereto. The pH of the mixture was adjusted to 11, 30 g of MgCl₂ was added to the reactor, and the reactor was heated to 95° C. step by step. The mixture was reacted at 95° C. for 2 hours, and reacted with NaCl for an additional 2 hours to obtain the primary agglomerated toner. 50 g of the secondary latex was added to the primary agglomerated toner and reacted for 6 hours, and cooled to a temperature of 25° C. below Tg. Then, the mixture was filtered to separate toner particles and dried. The dried toner particles are subjected to a surface treatment using silica, such as a mixture of H05TD (Wacker) and RX200 (NIPP. ON Aerosil) in a ratio of 2:1.

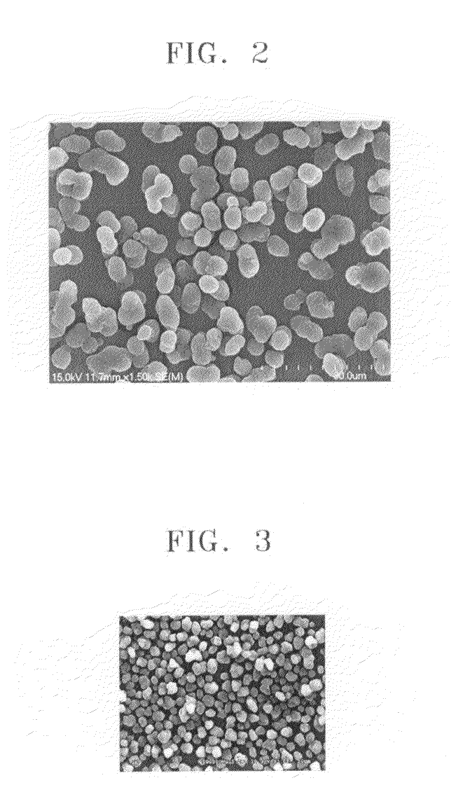

As a result, the prepared toner particles had a volume average diameter of about 6.8 μm in an intermediate shape between potato-shaped and spherical shape, and a SEM image thereof is shown in FIG. 2.

### EXAMPLE 2

Toner was prepared in the same manner as in Example 1, except that 100 g of a polymerizable monomer mixture of styrene, n-butyl acrylate, and methacrylic acid in a weight ratio of 70:28:2 was used during the preparation of the latex particles for the core. The prepared toner was potato-shaped and had a volume average diameter of about 7.3 μm. A SEM image thereof is shown in FIG. 3.

### EXAMPLE 3

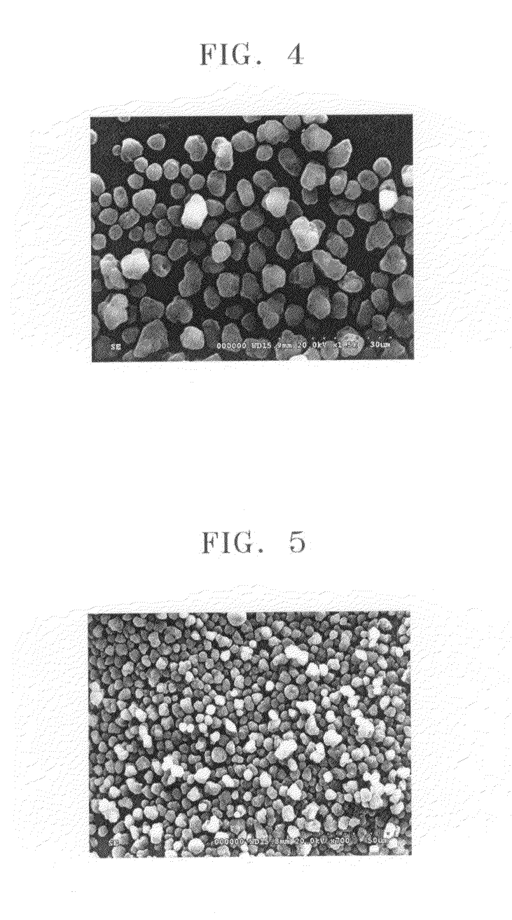

Toner was prepared in the same manner as in Example 2, except that cyan pigment was used instead of black pigment during agglomeration. The prepared toner was potato-shaped and had a volume average diameter of about 7.2 μm. A SEM image thereof is shown in FIG. 4.

### EXAMPLE 4

Toner was prepared in the same manner as in Example 2, except that yellow pigment was used instead of black pigment during agglomeration. The prepared toner was potato-shaped and had a volume average diameter of about 7.5 μm. A SEM image thereof is shown in FIG. 5.

### EXAMPLE 5

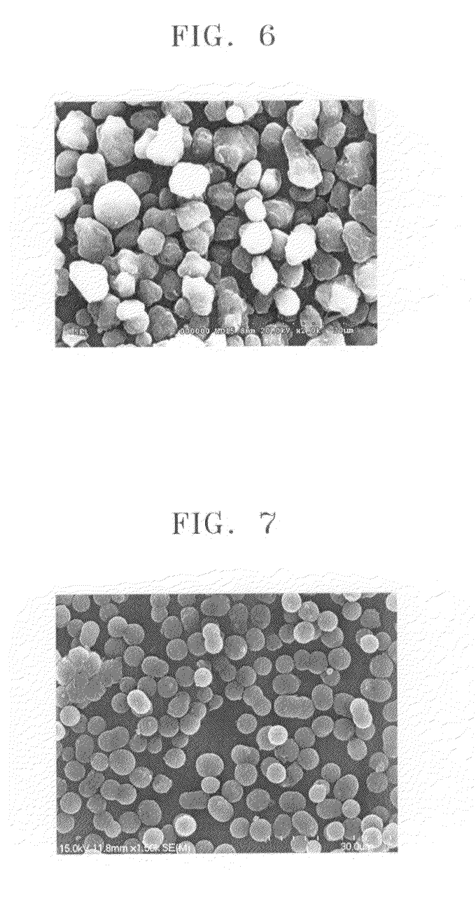

Toner was prepared in the same manner as in Example 2, except that magenta pigment was used instead of black pigment during agglomeration. The prepared toner was potato-shaped and had a volume average diameter of about 7.2 μm. A SEM image thereof is shown in FIG. 6.

### COMPARATIVE EXAMPLE 1

Toner was prepared in the same manner as in Example 1, except that the secondary latex was not added and reaction was performed for 8 hours. The prepared toner was spherical and had a volume average diameter of about 6.45 μm. A SEM image thereof is shown in FIG. 7.

### COMPARATIVE EXAMPLE 2

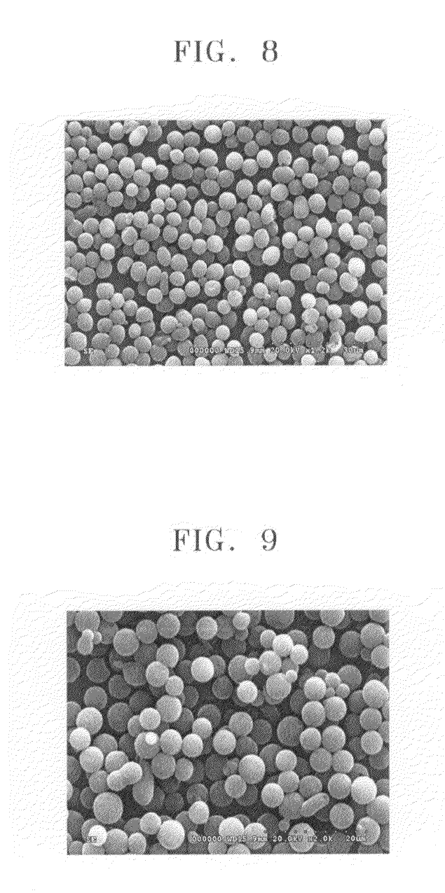

Toner was prepared in the same manner as in Example 2, except that the secondary latex was not added and reaction was performed for 8 hours. The prepared toner was spherical and had a volume average diameter of about 6.4 μm. A SEM image thereof is shown in FIG. 8.

### COMPARATIVE EXAMPLE 3

Toner was prepared in the same manner as in Example 3, except that the secondary latex was not added and reaction was performed for 8 hours. The prepared toner was spherical and had a volume average diameter of about 6.4 μm. A SEM image thereof is shown in FIG. 9.

### COMPARATIVE EXAMPLE 4

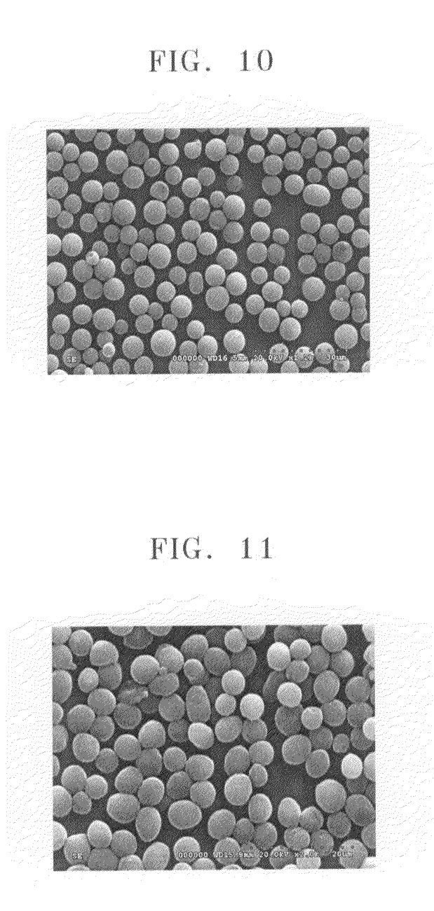

Toner was prepared in the same manner as in Example 4, except that the secondary latex was not added and reaction was performed for 8 hours. The prepared toner was spherical and had a volume average diameter of about 6.4 μm. A SEM image thereof is shown in FIG. 10.

### COMPARATIVE EXAMPLE 5

Toner was prepared in the same manner as in Example 5, except that the secondary latex was not added and reaction was performed for 8 hours. The prepared toner was spherical and had a volume average diameter of about 6.4 μm. A SEM image thereof is shown in FIG. 11.

Image Test

Solid Optical Density (Solid OD)

A piece of white paper was set as 0.00 value using GretagMacbeth™ D19C. Then, an output was placed on the white paper and optical density of a desired region was measured by pressing a button. Here, the optical density (OD) was evaluated using 200^{th} printed output.

Fusing Ratio

An optical density A of a solid image was measured, and the output was taped using a 3M magic tape 810. Then, an image of the taped region was worn by moving a weight wrapped with gauze back and forth (5 times repeated using a 500 g weight). The tape was taken off and an optical density B of the image was measured using GretagMacbeth™ D19C, and a fusing ratio was calculated using the following equation.

Fusing ratio=B/A×100(%)

The fusing ratio was indicated as follows:

Δ: in the range of 80 to 90%;

∘: greater than 90%; and

X: less than 80%.

Glossiness

Calibration was done using a glossimeter (BYK Inc., micro-tri-gloss) with a cover. Then, the output was placed on white paper and glossiness of a desired region was measured by pressing a button.

The optical density, fusing ratio and glossiness of images employing toner prepared according to Examples 1 through 5 and Comparative Examples 1 through 5 were measured according to the image test processes described above, and the results are shown in Table 1 below.

TABLE 1

| | Solid optical density | | |
|---|---|---|---|
| | (Solid OD) | | |
| | (using 200^{th} output) | Fusing ratio | Glossiness |
| Example 1 | 1.290 | ∘ | 2.1 |
| Example 2 | 1.272 | ∘ | 2.1 |
| Example 3 | 1.298 | ∘ | 2.1 |
| Example 4 | 1.285 | ∘ | 2.1 |
| Example 5 | 1.312 | ∘ | 2.1 |
| Comparative Example 1 | 1.210 | Δ | 1.5 |
| Comparative Example 2 | 1.132 | Δ | 1.5 |
| Comparative Example 3 | 1.245 | Δ | 1.5 |
| Comparative Example 4 | 1.238 | Δ | 1.5 |
| Comparative Example 5 | 1.246 | Δ | 1.5 |

As a result of the test, fusing ratio, optical density, and glossiness of images employing toner prepared according to Examples 1 through 5 were improved compared to those according to Comparative Examples 1 through 5.

According to the present invention, the manufacture process of toner can be simplified, the amount of wastewater can be minimized by reducing the amount of a surfactant, charge stability, durability, fusing ratio and glossiness of the final toner can be improved by coating the secondary latex having a relatively higher Tg than the primary latex and including a wax layer and a shell layer, and the shape and size of toner particles can be regulated.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing toner, the method comprising:
preparing a primary latex by polymerizing a toner composition comprising a macromonomer including a hydrophilic group, a hydrophobic group and at least one reactive functional group, and at least one polymerizable monomer;
preparing a primary agglomerated toner by mixing the primary latex with a pigment dispersion dispersed by the macromonomer and adding an inorganic salt to the resulting mixture; and
coating the primary agglomerated toner using a secondary latex comprising a core formed by polymerizing the macromonomer and at least one polymerizable monomer, a wax layer formed on the core by applying a dispersion in which at least one polymerizable monomer is dispersed in a wax, and a shell layer formed on the wax layer by adding at least one polymerizable monomer to the wax layer on the core.

2. The method of claim 1, wherein the macromonomer is selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

3. The method of claim 1, wherein the weight average molecular weight of the macromonomer is in the range of about 100 to about 100,000.

4. The method of claim 1, wherein the amount of the macromonomer is in the range of about 0.1 to about 10 parts by weight based on 100 parts by weight of the polymerizable monomer.

5. The method of claim 1, wherein the polymerizable monomer is at least one monomer selected from the group consisting of a vinyl monomer, a polar monomer having a carboxyl group, a monomer having an unsaturated polyester group, and a monomer having a fatty acid group.

6. The method of claim 1, wherein the polymerizable monomer is at least one selected from the group consisting of styrene, vinyl toluene, α-methyl styrene; acrylic acid, methacrylic acid; methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide; ethylene, propylene, butylenes; vinyl chloride, vinylidene chloride, vinyl fluoride; vinyl acetate, vinyl propionate; vinyl methyl ether, vinyl ethyl ether; vinyl methyl ketone, methyl isoprophenyl ketone; 2-vinylpyridine, 4-vinylpyridine, and N-vinyl pyrrolidone.

7. The method of claim 1, wherein the polymerizable monomer is at least one selected from the group consisting of styrene based monomers, (meth)acrylate derivatives, ethylenically unsaturated monoolefins, halogenated vinyls, vinyl esters, vinyl ethers, vinyl ketones, and nitrogen containing vinyl compounds.

8. The method of claim 1, wherein the pigment is selected from the group consisting of yellow, magenta, cyan and black pigment.

9. The method of claim 1, wherein the inorganic salt is at least one selected from the group consisting of NaCl, MgCl₂.8H₂O, and [Al₂(OH)ₙCl₆₋ₙ]ₘ where 1≦n≦5, 1≦m≦10, and (Al₂(SO₄)₃.18H₂O).

10. The method of claim 1, wherein the primary latex comprises a wax layer formed from a dispersion in which at least one polymerizable monomer is dispersed in a wax.

11. The method of claim 1, wherein at least one operation of the preparation of the primary latex, the preparation of the primary agglomerated toner, and the coating the primary agglomerated toner using the secondary latex is carried out without a surfactant.

12. The method of claim 1, wherein the core of the secondary latex comprises a charge control agent.

13. The method of claim 1, wherein the preparation of the primary latex is carried out using at least one component selected from the group consisting of an initiator, a chain transfer agent, a charge control agent, and a release agent.

14. A toner prepared by a method according to claim 1.

15. A toner prepared by a method comprising: preparing a primary latex by polymerizing a toner composition comprising a macromonomer having a hydrophilic group, a hydrophobic group and at least one reactive functional group, and at least one polymerizable monomer; preparing a primary agglomerated toner by mixing the primary latex with a pigment dispersion dispersed in the macromonomer and adding an inorganic salt to the resulting mixture to obtain the primary agglomerated toner; and coating the primary agglomerated toner using a secondary latex comprising a core formed by polymerizing the macromonomer and at least one polymerizable monomer, a wax layer formed on the core by applying a dispersion in which at least one polymerizable monomer is dispersed in a wax, and a shell layer formed on the wax layer by adding at least one polymerizable monomer to the wax layer.

16. The toner of claim 15, wherein at least one operation of the preparation of the primary latex, the preparing a primary agglomerated toner, and the coating the primary agglomerated toner using a secondary latex is carried out without a surfactant.

17. The toner of claim 15, wherein a volume average diameter of particles of the toner is in the range of about 3 to about 20 μm.

18. The toner of claim 15, wherein the macromonomer is selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

19. The toner of claim 15, wherein the toner further comprises at least one component selected from the group consisting of an initiator, a chain transfer agent, a charge control agent, and a release agent.

20. A method of forming an image, the method comprising attaching a toner of claim 15 to the surface of a photoreceptor on which an electrostatic latent image is formed to form a visualized image and transferring the visualized image to a transfer medium.

21. An image forming apparatus comprising:
an organic photoreceptor;
an image forming unit that forms an electrostatic latent image on a surface of the organic photoreceptor;
a unit for receiving toner according to claim 15;
a toner supplying unit that supplies the toner onto the surface of the organic photoreceptor in order to form a toner image by developing the electrostatic latent image; and
a toner transferring unit that transfers the toner image to a transfer medium from the surface of the organic photoreceptor.
